(19) United States
(12) Patent Application Publication
(10) Pub. No.: US 2026/0237339 A1
(43) Pub. Date: Aug. 13, 2026

(54) DISPLAY DEVICE, CONTROL METHOD AND APPARATUS, AND STORAGE MEDIUM

(71) Applicants: Hefei BOE Joint Technology Co., Ltd., Hefei, Anhui (CN); BOE Technology Group Co., Ltd., Beijing (CN)

(72) Inventors: Huihui LI, Beijing (CN); Song MENG, Beijing (CN); Yao ZHANG, Beijing (CN); Miao LIU, Beijing (CN)

(21) Appl. No.: 19/159,257

(22) PCT Filed: Jun. 12, 2024
(86) PCT No.: PCT/CN2024/098700

§ 371 Date: Aug. 22, 2025

(30) Foreign Application Priority Data
Jul. 13, 2023 (CN) 202310865927.0

(51) Int. Cl. G09G 3/20; G09G 3/3233

(52) U.S. Cl. CPC G09G 3/2096; G09G 3/2007; G09G 3/3233; G09G 2300/0408; G09G 2300/0804; G09G 2300/0819; G09G 2300/0842; G09G 2310/06; G09G 2310/08; G09G 2320/0233; G09G 2320/0257; G09G 2320/045; G09G 2320/0693

(57) ABSTRACT

A display device, a control method, a control apparatus, and a storage medium are provided. The display device includes: a timing controller configured to correct initial pixel data of a target pixel unit to obtain target pixel data, and output the target pixel data to a data signal driver, wherein the target pixel data is configured to increase a forward bias of a driving transistor of a pixel driving circuit of the target pixel unit under a normal operation scene; the data signal driver configured to output a driving voltage matching with the target pixel data to the target pixel unit so as to enable the driving transistor to keep forward biased in the normal operation scene.

### CROSS-REFERENCE TO RELATED APPLICATIONS

This is a National Phase Application filed under 35 U.S.C. 371 as a national stage of PCT/CN2024/098700 filed on Jun. 12, 2024, an application claiming priority to Chinese patent application No. 202310865927.0, filed on Jul. 13, 2023, the entire content of each of which is incorporated herein by reference.

### TECHNICAL FIELD

The present disclosure relates to the field of display technologies, and in particular, to a display device, a control method, a control apparatus, and a storage medium.

### BACKGROUND

An organic light emitting diode (OLED) device belongs to a current type organic light emitting device, and emits light through injection and recombination of carriers, where an intensity of the emitted light is in direct proportion to an injected current. Under the action of an electric field, holes generated by an anode of an OLED and electrons generated by a cathode of the OLED will move to be injected into a hole transport layer and an electron transport layer, respectively, and migrate to a light emitting layer. When the holes and the electrons meet together at the light emitting layer, energy excitons are generated, thereby exciting light emitting molecules to generate visible light finally.

An OLED display screen has the advantages of low power consumption, fast response speed, high resolution, and the like, and thus is more and more widely applied to electronic devices.

### SUMMARY

The present disclosure provides a display device, a control method, a control apparatus, and a storage medium, to solve the above technical problems.

According to a first aspect of the present disclosure, there is provided a display device including a timing controller, a pixel array, and a data signal driver; wherein each of pixel units of the pixel array includes a light emitting device and a pixel driving circuit for driving the light emitting device to emit light, the pixel driving circuit includes a driving transistor, the timing controller is electrically connected to the data signal driver, and the data signal driver is electrically connected to the pixel units;
the timing controller is configured to correct initial pixel data of a target pixel unit to obtain target pixel data, and output the target pixel data to the data signal driver; and the target pixel data is configured to increase a forward bias of the driving transistor of the pixel driving circuit of the target pixel unit under a normal operation scene; and
the data signal driver is configured to output a driving voltage matching with the target pixel data to the target pixel unit so as to enable the driving transistor to keep forward biased in the normal operation scene.

Optionally, to correct initial pixel data of a target pixel unit to obtain target pixel data, the timing controller is further configured to:
in a display control stage, determine whether the initial pixel data of the target pixel unit is a first preset gray level, and the first preset gray level is a gray level voltage which enables the light emitting device not to emit light;
in response to that it is determined that the initial pixel data of the target pixel unit is the first preset gray level, perform preset threshold voltage compensation on the initial pixel data to obtain intermediate pixel data; and
perform first preset correction voltage compensation on the intermediate pixel data to obtain the target pixel data;
wherein the target pixel data is configured to keep the driving transistor of the target pixel unit forward biased and make the light emitting device of the target pixel unit not emit light.

Optionally, to perform first preset correction voltage compensation on the intermediate pixel data to obtain the target pixel data, the timing controller is further configured to:
obtain a first preset correction voltage corresponding to the target pixel unit; and
obtain a difference between the intermediate pixel data and the first preset correction voltage as the target pixel data.

Optionally, to obtain a first preset correction voltage corresponding to the target pixel unit, the timing controller is further configured to:
set a correction voltage as an initial value and increase the correction voltage by a preset step length;
sequentially obtain differences between a preset threshold voltage and correction voltages as test pixel voltages;
sequentially output the test pixel voltages to the target pixel unit to obtain a first test pixel voltage that enables the target pixel unit to stop emitting light; and
take the correction voltage corresponding to the first test pixel voltage as the first preset correction voltage.

Optionally, to correct initial pixel data of a target pixel unit to obtain target pixel data, the timing controller is further configured to:
in a display control stage, obtain the target pixel unit and the initial pixel data of the target pixel unit;
perform preset threshold voltage compensation on the initial pixel data of the target pixel unit to obtain intermediate pixel data; and
perform second preset correction voltage compensation on the intermediate pixel data to obtain the target pixel data;
wherein the target pixel data is configured to keep the driving transistor of the target pixel unit forward biased and make an intensity of light emitted from the light emitting device of the target pixel unit different from an intensity of light emitted from an adjacent light emitting device.

Optionally, to obtain the target pixel unit and the initial pixel data of the target pixel unit, the timing controller is further configured to:
for each pixel unit in each row of pixel units of the display device, obtain a difference between pixel data of a present pixel unit and pixel data of a next pixel unit;
compare the difference with a preset difference threshold to obtain a comparison result; and
in response to that the comparison result indicates that the difference is greater than the preset difference threshold, determine the present pixel unit and at least one pixel unit previous to the present pixel unit as target pixel units, and obtain the pixel data of each of the target pixel units as the initial pixel data.

Optionally, to perform second preset correction voltage compensation on the intermediate pixel data to obtain the target pixel data, the timing controller is further configured to:
obtaining a second preset correction voltage of each target pixel unit, wherein the target pixel unit, which is farther from the present pixel unit, has a greater second preset correction voltage; and
obtain a difference between the intermediate pixel data and the second preset correction voltage of each target pixel unit as the target pixel data.

Optionally, to obtain the target pixel unit and the initial pixel data of the target pixel unit, the timing controller is further configured to:
in response to that the comparison result indicates that the difference is less than or equal to the preset difference threshold, determine that the present pixel unit is not the target pixel unit.

Optionally, to obtain the target pixel unit and the initial pixel data of the target pixel unit, the timing controller is further configured to:
for each pixel unit in each row of pixel units of the display device, obtain a difference between pixel data of a present pixel unit and pixel data of a next pixel unit;
compare the difference with a preset difference threshold to obtain a comparison result; and
in response that the comparison result indicates that the difference is greater than the preset difference threshold, determine the present pixel unit and at least one pixel unit next to the present pixel unit as target pixel units, and obtain the pixel data of each of the target pixel units as the initial pixel data.

Optionally, to perform second preset correction voltage compensation on the intermediate pixel data to obtain the target pixel data, the timing controller is further configured to:
obtaining a second preset correction voltage of each target pixel unit, wherein the target pixel unit, which is farther from the present pixel unit, has a smaller second preset correction voltage; and
obtain a difference between the intermediate pixel data and the second preset correction voltage of each target pixel unit as the target pixel data.

Optionally, to obtain the target pixel unit and the initial pixel data of the target pixel unit, the timing controller is further configured to:
in response to that the comparison result indicates that the difference is less than or equal to the preset difference threshold, determine that the present pixel unit is not the target pixel unit.

Optionally, the pixel driving circuit of each pixel unit includes a correction switch, a first terminal of the correction switch is electrically connected to a source electrode of the driving transistor of the pixel driving circuit, and a second terminal of the correction switch is electrically connected to a preset level line; to correct initial pixel data of a target pixel unit to obtain target pixel data, the timing controller is further configured to:
in a non-display control stage, control the correction switch to be turned on so as to write a preset level on the preset level line into the source electrode of the driving transistor;
in a first stage of the non-display control stage, adjust the initial pixel data of the target pixel unit to a first voltage as the target pixel data, wherein the first voltage is greater than a gray level voltage of the initial pixel data;
in a second stage of the non-display control stage, adjust the initial pixel data of the target pixel unit to a second voltage as the target pixel data, wherein the second voltage is equal to the preset level output from the preset level line; and
in a third stage of the non-display control stage, adjust the initial pixel data of the target pixel unit to pixel data of a previous frame of image as the target pixel data.

According to a second aspect of the present disclosure, there is provided a control method applicable to a display device, the control method including:
correcting initial pixel data of a target pixel unit to obtain target pixel data, wherein the target pixel data is configured to increase a forward bias of a driving transistor of the target pixel unit under a normal operation scene; and
outputting the target pixel data to the target pixel unit.

Optionally, the correcting initial pixel data of a target pixel unit to obtain target pixel data includes:
in a display control stage, determining whether the initial pixel data of the target pixel unit is a first preset gray level;
in response to that it is determined that the initial pixel data of the target pixel unit is the first preset gray level, performing preset threshold voltage compensation on the initial pixel data to obtain intermediate pixel data; and
performing first preset correction voltage compensation on the intermediate pixel data to obtain the target pixel data;
wherein the target pixel data is configured to keep the driving transistor of the target pixel unit forward biased and make the light emitting device of the target pixel unit not emit light.

Optionally, the performing first preset correction voltage compensation on the intermediate pixel data to obtain the target pixel data includes:
obtaining a first preset correction voltage corresponding to the target pixel unit; and
obtaining a difference between the intermediate pixel data and the first preset correction voltage as the target pixel data.

Optionally, the obtaining a first preset correction voltage corresponding to the target pixel unit includes:
setting a correction voltage as an initial value and increase the correction voltage by a preset step length;
sequentially obtaining differences between a preset threshold voltage and correction voltages as test pixel voltages;
sequentially outputting the test pixel voltages to the target pixel unit to obtain a first test pixel voltage that enables the target pixel unit to stop emitting light; and
taking the correction voltage corresponding to the first test pixel voltage as the first preset correction voltage.

Optionally, the correcting initial pixel data of a target pixel unit to obtain target pixel data includes:
in a display control stage, obtaining the target pixel unit and the initial pixel data of the target pixel unit;
performing preset threshold voltage compensation on the initial pixel data of the target pixel unit to obtain intermediate pixel data; and
performing second preset correction voltage compensation on the intermediate pixel data to obtain the target pixel data;
wherein the target pixel data is configured to keep the driving transistor of the target pixel unit forward biased and make an intensity of light emitted from the light emitting device of the target pixel unit different from an intensity of light emitted from an adjacent light emitting device.

Optionally, the obtaining the target pixel unit and the initial pixel data of the target pixel unit includes:
for each pixel unit in each row of pixel units of the display device, obtaining a difference between pixel data of a present pixel unit and pixel data of a next pixel unit;
comparing the difference with a preset difference threshold to obtain a comparison result; and
in response to that the comparison result indicates that the difference is greater than the preset difference threshold, determining the present pixel unit and at least one pixel unit previous to the present pixel unit as target pixel units, and obtaining the pixel data of each of the target pixel units as the initial pixel data.

Optionally, the performing second preset correction voltage compensation on the intermediate pixel data to obtain the target pixel data includes:
obtaining a second preset correction voltage of each target pixel unit, wherein the target pixel unit, which is farther from the present pixel unit, has a greater second preset correction voltage; and
obtaining a difference between the intermediate pixel data and the second preset correction voltage of each target pixel unit as the target pixel data.

Optionally, the obtaining the target pixel unit and the initial pixel data of the target pixel unit further includes:
in response to that the comparison result indicates that the difference is less than or equal to the preset difference threshold, determining that the present pixel unit is not the target pixel unit.

Optionally, the obtaining the target pixel unit and the initial pixel data of the target pixel unit includes:
for each pixel unit in each row of pixel units of the display device, obtaining a difference between pixel data of a present pixel unit and pixel data of a next pixel unit;
comparing the difference with a preset difference threshold to obtain a comparison result; and
in response that the comparison result indicates that the difference is greater than the preset difference threshold, determining the present pixel unit and at least one pixel unit next to the present pixel unit as target pixel units, and obtaining the pixel data of each of the target pixel units as the initial pixel data.

Optionally, the performing second preset correction voltage compensation on the intermediate pixel data to obtain the target pixel data includes:
obtaining a second preset correction voltage of each target pixel unit, wherein the target pixel unit, which is farther from the present pixel unit, has a smaller second preset correction voltage; and
obtaining a difference between the intermediate pixel data and the second preset correction voltage of each target pixel unit as the target pixel data.

Optionally, the obtaining the target pixel unit and the initial pixel data of the target pixel unit further includes:
in response to that the comparison result indicates that the difference is less than or equal to the preset difference threshold, determining that the present pixel unit is not the target pixel unit.

Optionally, the pixel driving circuit of each pixel unit includes a correction switch, a first terminal of the correction switch is electrically connected to a source electrode of the driving transistor of the pixel driving circuit, and a second terminal of the correction switch is electrically connected to a preset level line; the correcting initial pixel data of a target pixel unit to obtain target pixel data includes:
in a non-display control stage, controlling the correction switch to be turned on so as to write a preset level on the preset level line into the source electrode of the driving transistor;
in a first stage of the non-display control stage, adjusting the initial pixel data of the target pixel unit to a first voltage as the target pixel data, wherein the first voltage is greater than a gray level voltage of the initial pixel data;
in a second stage of the non-display control stage, adjusting the initial pixel data of the target pixel unit to a second voltage as the target pixel data, wherein the second voltage is equal to the preset level output from the preset level line; and
in a third stage of the non-display control stage, adjusting the initial pixel data of the target pixel unit to pixel data of a previous frame of image as the target pixel data.

According to a third aspect of the present disclosure, there is provided a control apparatus applicable to a display device, the control apparatus including:
a target data acquirer configured to correct initial pixel data of a target pixel unit to obtain target pixel data, wherein the target pixel data is configured to increase a forward bias of a driving transistor of the target pixel unit under a normal operation scene; and
a target data output unit configured to output the target pixel data to the target pixel unit.

According to a fourth aspect of the present disclosure, there is provided a non-transitory computer readable storage medium, having an executable computer program stored therein, wherein when executed by a processor, the computer program implements the control method according to any one of embodiments of the second aspect.

The technical solutions provided by the embodiments of the present disclosure can achieve at least the following beneficial effects.

The timing controller of the display device among the solutions provided by the embodiments can correct the initial pixel data of each target pixel unit to obtain the target pixel data, where the target pixel data is configured to increase the forward bias of the driving transistor of the target pixel unit under a normal operation scene; and then, the timing controller can output the target pixel data to the data signal driver. As such, in the embodiments, the pixel data is corrected such that the target pixel data can increase the forward bias of the driving transistor of the target pixel unit, thereby mitigating or eliminating the surface residual image and/or the line residual image caused by the negative drift of the threshold voltage of the driving transistor, which facilitates the improvement of the display quality.

It is to be understood that both the foregoing general description and the following detailed description are exemplary and explanatory only and are not intended to limit the present disclosure.

### BRIEF DESCRIPTION OF THE DRAWINGS

FIG. 1 is a block diagram of a display device according to an embodiment of the present disclosure.

FIG. 2 is a schematic diagram of a pixel driving circuit according to an embodiment of the present disclosure.

FIG. 3 is a flowchart of a control method according to an embodiment of the present disclosure.

FIG. 4 is a flowchart for obtaining target pixel data according to an embodiment of the present disclosure.

FIG. 5 is a graph illustrating target pixel data in a same row in a case of displaying a black image according to an embodiment of the present disclosure.

FIG. 6 is a schematic diagram of a black and white checkerboard image according to an embodiment of the present disclosure.

FIG. 7 is a flowchart for obtaining target pixel data according to an embodiment of the present disclosure.

FIG. 8 is a schematic diagram of a graph of pixel data of a target pixel unit, before and after adjustment of the pixel data, according to an embodiment of the present disclosure.

FIG. 9 is a flowchart for obtaining initial pixel data according to an embodiment of the present disclosure.

FIG. 10 is a schematic diagram of a graph of pixel data of a target pixel unit, before and after adjustment of the pixel data, according to an embodiment of the present disclosure.

FIG. 11 is a schematic diagram of a control timing sequence according to an embodiment of the present disclosure.

FIG. 12 is a timing diagram illustrating a non-display control stage according to an embodiment of the present disclosure.

FIG. 13 is a flowchart of a control method according to an embodiment of the present disclosure.

FIG. 14 is a flowchart of another control method according to an embodiment of the present disclosure.

FIG. 15 is a flowchart of another control method according to an embodiment of the present disclosure.

FIG. 16 is a block diagram of a control apparatus according to an embodiment of the present disclosure.

### DETAILED DESCRIPTION OF EMBODIMENTS

Description will now be made in detail to the exemplary embodiments, examples of which are illustrated in the accompanying drawings. The following description refers to the accompanying drawings in which a same reference symbol in different figures represents the same or similar elements unless otherwise indicated. The implementations described in the exemplary embodiments below do not represent all implementations consistent with the present disclosure. Rather, they are merely examples of devices consistent with certain aspects of the present disclosure, as detailed in the appended claims.

In practical applications, the OLED display screen may generate a surface residual image and/or a line residual image during operations. In the course of achieving the solutions of the present disclosure, the inventors found that the reason for the line residual image is that light emitted from light emitting devices (e.g., OLEDs) in a higher luminance region causes physical properties, such as a carrier concentration, of a thin film transistor of a pixel driving circuit in a lower luminance region to be changed, and finally a turn-on voltage of the thin film transistor becomes smaller, i.e. the turn-on voltage Vth of the thin film transistor becomes smaller, which is also referred to as a negative drift of a threshold voltage Vth. When the negative drift of the threshold voltage Vth occurs, a luminance of a corresponding light emitting device is increased; and an increase in luminance of light emitting devices in several rows or several columns will result in the line residual image.

A current formula of each of the light emitting devices is as shown in formula (1).

$${I}_{g s} = {K ( {V}_{g s} - {V}_{t h} )}^{2} . \qquad ( 1 )$$

In formula (1), I_{gs} represents an electric current between a gate electrode and a source electrode of the driving transistor in the pixel driving circuit; K represents a simplified value of a plurality of physical parameters of the driving transistor and is known in a case where the driving transistor is given, i.e. K is known; V_{gs} represents a voltage between the gate electrode and the source electrode of the driving transistor; and Vₜₕ represents the threshold voltage of the driving transistor.

In this example, since V_{gs}=V_{g}−Vₛ+Vₜₕ₁, formula (1) may be converted to the following formula (2).

$${I}_{g s} = {K ( {V}_{g} - {V}_{s} + {V}_{th 1} - {V}_{th 2} )}^{2} . \qquad ( 2 )$$

In formula (2), V_{g} represents a voltage at the gate electrode of the driving transistor; Vₛ represents a voltage at the source electrode of the driving transistor; and Vₜₕ₁ and Vₜₕ₂ represent threshold voltages of the driving transistor, respectively.

Theoretically, Vₜₕ₁ and Vₜₕ₂ are equal to each other; in this case, a threshold voltage Vₜₕ₁ is added to the pixel data, and a threshold voltage Vₜₕ₂ is subtracted from formula (2) to achieve the effect of eliminating the threshold voltage Vth; in this way, the driving transistor can be compensated.

In practical applications, the threshold voltage Vₜₕ₂ is an actual turn-on voltage of the driving transistor itself. The threshold voltage Vₜₕ₁ is a detection value, which is detected by a sense line of the OLED display screen and stored in a timing controller (which may be referred to as “TCON”), and after obtaining pixel data of each pixel unit, compensation is performed by using the threshold voltage Vₜₕ₁, so as to obtain the final pixel data Data. The sense line detects the threshold voltage Vₜₕ₁ according to a certain period, such as one hour, one day, or at the time when the OLED display screen is turned on or off, and the threshold voltage Vₜₕ₁ is used for characterizing the threshold voltage Vₜₕ₂ before the next detection.

It should be noted that, at the time of each detection, Vₜₕ₁ and Vₜₕ₂ are equal to each other. After the present detection and before the next detection, the physical characteristics of the driving transistor are influenced by the adjacent light emitting devices, and the threshold voltage Vₜₕ₂ will undergo a negative drift, such that the threshold voltage Vₜₕ₁ is not equal to the threshold voltage Vₜₕ₂ any more, and a difference exists between the threshold voltage Vₜₕ₁ and the threshold voltage Vₜₕ₂. As such, the light emitting devices become brighter, and the line residual image or the surface residual image is generated.

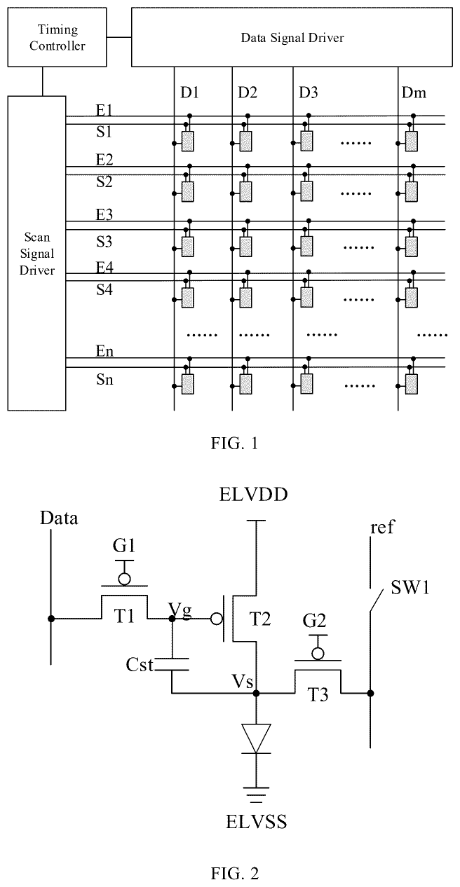

In order to solve the foregoing technical problems, embodiments of the present disclosure provide a display device, a control method, a control apparatus, and a storage medium. The display device may include, but is not limited to, a mobile phone, a computer, a tablet, an electronic book, a watch, a stereoscopic display screen, a conference machine, an electronic whiteboard, or other devices with display functions. The display device includes a display device. Referring to FIG. 1, the display device includes a timing controller, a pixel array, a scan signal driver, and a data signal driver. Each of pixel units in the pixel array includes a light emitting device and a pixel driving circuit for driving the light emitting device to emit light. A structure of the light emitting device of each pixel unit includes various structures, and may be selected according to practical requirements. For example, the light emitting device may be an OLED, a quantum dot light emitting diode (QLED), a micro light emitting diode (Micro LED), or the like, and may be selected according to an application scene and is not limited herein. The scan signal driver and the data signal driver may be implemented by circuits in the related art, and detailed description thereof is omitted herein.

In an embodiment, the pixel driving circuit may be implemented with different circuit structures, such as 7T1C (i.e., 7 transistors and 1 capacitor), 8T1C (i.e., 8 transistors and 1 capacitor), or the like, and one of ordinary skill in the art may select a suitable circuit structure according to an application scenario to implement a method provided in the present disclosure. In an example, the pixel driving circuit may be simplified to the circuit structure as shown in FIG. 2.

In an example, the pixel driving circuit includes a driving transistor and a correction switch. Referring to FIG. 2, a first terminal of the correction switch SW1 is electrically connected to a source electrode of the driving transistor T2 of the pixel driving circuit, and a second terminal of the correction switch SW1 is electrically connected to a preset level line ref. The correction switch SW1 is configured to write a preset level Vref of the preset level line ref into the source electrode of the driving transistor T2 during the non-display control stage. It will be appreciated that the preset level Vref may be 0 V or another voltage, and in an example, Vref=0 V.

In an example, with continuing reference to FIG. 2, the pixel driving circuit further includes a first transistor T1, a third transistor T3, and a storage capacitor Cst. The first transistor T1 is connected in series between a data line Data and a gate electrode of the driving transistor T2, and is configured to control the writing of pixel data on the data line Data into the gate electrode of the driving transistor T2, thereby controlling an intensity of light emitted from a light emitting device. The storage capacitor Cst is configured to store the pixel data to enable the driving transistor T2 to continuously output a driving current to drive the light emitting device to emit light. The third transistor T3 is configured to cooperate with the correction switch SW1 to write the preset level Vref into the source electrode of the driving transistor T2 as a reference level.

It should be noted that a control signal G1 for the first transistor T1 may be provided from a GOA (i.e., Gate Driver on Array) circuit of 10T3C, 12T3C, 13T3C, or 16T3C, which may be selected according to an application scenario and is not limited herein. A control signal G2 for the third transistor T3 may be provided from the GOA circuit of 10T3C, 12T3C, 13T3C or 16T3C, which may be selected according to an application scenario and is not limited herein.

It should be understood that each transistor in the circuit shown in FIG. 2 may be implemented by an N-type transistor or a P-type transistor. For convenience of description, the driving transistor T2 in the circuit shown in FIG. 2 is implemented by an N-type switching device, i.e., a turn-on voltage of the driving transistor T2 is a high level, and each of the first transistor T1 and the third transistor T3 may be of any type, which is not limited herein.

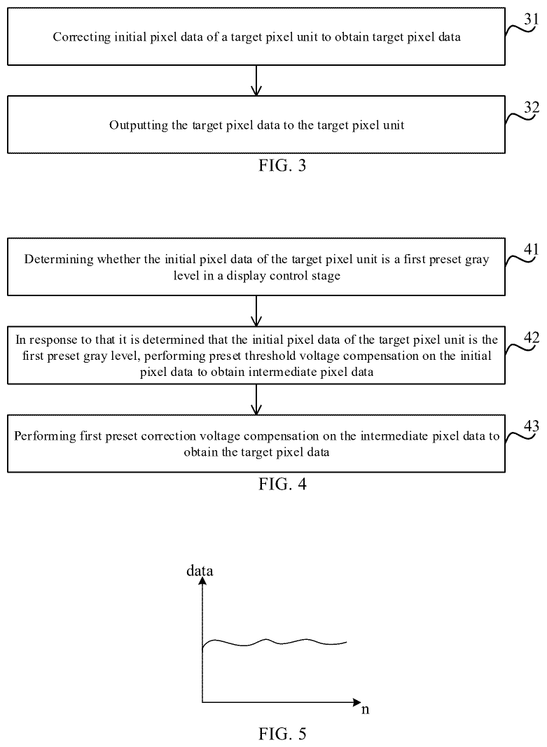

In connection with the display device shown in FIGS. 1-2, a timing controller (TCON) in the display device may be configured to perform a control method including steps 31 to 32, as shown in FIG. 3.

In step 31, the timing controller corrects initial pixel data of a target pixel unit to obtain target pixel data, where the target pixel data is configured to increase a forward bias of a driving transistor of the target pixel unit under a normal operation scene.

In an example, the target pixel unit includes a pixel unit to display a black pattern. The timing controller can correct the initial pixel data of the target pixel unit to obtain the target pixel data, including steps 41 to 43, as shown in FIG. 4.

Step 41 includes determining whether the initial pixel data of the target pixel unit is a first preset gray level in a display control stage.

In the present step, the display control stage (which is also referred to as an “active stage”) is a stage of driving the light emitting device to emit light according to a preset control timing sequence, and for example, the display control stage may include an initialization stage, a data writing stage, a light emitting stage, a reset stage, and the like.

In the present step, the timing controller may obtain pixel data of an image to be displayed, and herein, such pixel data is referred to as the initial pixel data to distinguish it from another. Then, the timing controller may determine whether the initial pixel data of each pixel unit is the first preset gray level, and for example, a gray level of 0 indicates that the pixel unit is to display black or the pixel unit will not emit light. In this way, the timing controller may obtain a target pixel unit of which the initial pixel data is the first preset gray level and a non-target pixel unit of which the initial pixel data is not the first preset gray level.

Step 42 includes, in response to that it is determined that the initial pixel data of the target pixel unit is the first preset gray level, performing preset threshold voltage compensation on the initial pixel data to obtain intermediate pixel data.

In the present step, in response to that it is determined that the initial pixel data is the first preset gray level, the timing controller may perform the preset threshold voltage compensation on the initial pixel data to obtain the intermediate pixel data. Assuming that the initial pixel data is Data0, the preset threshold voltage is Vth1, and the intermediate pixel data is Data1, Data1=Data0+Vth1. In combination with the content of formula (1), the compensation on the pixel data in the present step is to compensate V_{gs}, so as to eliminate the threshold voltage of the driving transistor and ensure to accurately turn on or off the driving transistor.

Step 43 includes performing a first preset correction voltage compensation on the intermediate pixel data to obtain the target pixel data, where the target pixel data is configured to keep the driving transistor of the target pixel unit forward biased and make the light emitting device of the target pixel unit not emit light.

In the present step, a first preset correction voltage is stored in the display device, and for example, the first preset correction voltage may be stored in the timing controller of the display device. It should be noted that first preset correction voltages of the pixel units have different values, i.e., each pixel unit is provided with a first preset correction voltage matched with the pixel unit. The first preset correction voltage for each pixel unit can be obtained by testing in the following ways.

The timing controller may initialize the correction voltage, and set the correction voltage to an initial value, which may be 0V. Then, the timing controller increases the correction voltage according to a preset step, and assuming that the initial value of the correction voltage is A0 (which is, for example, 0V and adjustable) and a step is S (which is, for example, 0.001V and adjustable), A1=A0+S1=A0+S, A2=A0+S2=A0+2S, and so on, An=A0+nS, thereby obtaining a plurality of correction voltages, which are values to be tested. The timing controller may obtain a difference between the preset threshold voltage and each correction voltage as a test pixel voltage, when obtaining the correction voltage, where the test pixel voltage is Vth1−An. It should be noted that the preset threshold voltage may be a latest detection value at the sense line of the display device, so as to ensure the reliability of the correction process.

It can be understood that, considering that the initial pixel data is 0 if the initial pixel data is the first preset gray level, the pixel unit displays a black image, i.e., the pixel unit does not emit light, and thus the difference Vth1−An between the preset threshold voltage and the correction voltage can be regarded as the test pixel voltage 0+Vth1−An.

Then, after the display device operates for a certain time, for example, replaying a video with a preset duration, displaying a text with a preset duration, displaying a webpage with a preset duration, and the like, to simulate the influence of a user use scene on the display device, i.e., the driving transistor in the pixel driving circuit may undergo a negative drift, the timing controller may output the test pixel voltage to the target pixel unit.

With continuing reference to formulas (1) and (2), since the threshold voltage Vth2 may undergo a negative drift, if the threshold voltage Vth2 does not undergo a negative drift, the test pixel voltage Vth1
An is less than the threshold voltage Vth2, and the driving transistor cannot be turned on, i.e., the target pixel unit does not emit light. If the threshold voltage Vth2 undergo a negative drift, the test pixel voltage Vth1
An may be greater than, equal to, or less than the threshold voltage Vth2, where if the test pixel voltage Vth1−An is less than or equal to the threshold voltage Vth2, the driving transistor cannot be turned on, i.e., the target pixel unit does not emit light; if the test pixel voltage Vth1−An is greater than the threshold voltage Vth2, the driving transistor can be turned on, i.e., the target pixel unit emits light.

It can be understood that, the test pixel voltage when the target pixel unit does not emit light is referred to as a first test pixel voltage, and the timing controller may use a correction voltage corresponding to the first test pixel voltage as the first preset correction voltage.

It can be understood that, when the target pixel unit emits light, the timing controller may output a next test pixel voltage next to the present test pixel voltage to the target pixel unit until the target pixel unit stops emitting light. The timing controller may use a calibration voltage corresponding to the present first test pixel voltage as the first preset calibration voltage.

Through the above process, the timing controller may detect the first preset correction voltage of each pixel unit, and store the first preset correction voltage at a designated location of the display device, such as the timing controller, a local memory, and the like, which is not limited herein.

In the present step, the timing controller may obtain the first preset correction voltage corresponding to the target pixel unit. Then, the timing controller may obtain a difference value between the intermediate pixel data and the first preset correction voltage of each target pixel unit as the target pixel data. In this way, by performing compensation once and correction once on the initial pixel data in the present step, the target pixel unit can still be kept forward biased when displaying a black image, i.e., Vgs (=Vg−Vs) is greater than 0 and less than Vth, and the voltage at the gate electrode of the driving transistor is greater than that at the source electrode of the driving transistor while ensuring that the target pixel unit does not emit light. Since the driving transistor keeps forward biased, the residual image caused by the negative drift of the threshold voltage of the driving transistor can be mitigated.

In this example, since the compensation and correction operations are performed for each pixel unit, the target pixel data detected when the pixel units in a same row display a black image is no longer 0, but is a numerical value related to the threshold voltage Vth of each of the pixel units, and the effect thereof is as shown in FIG. 5.

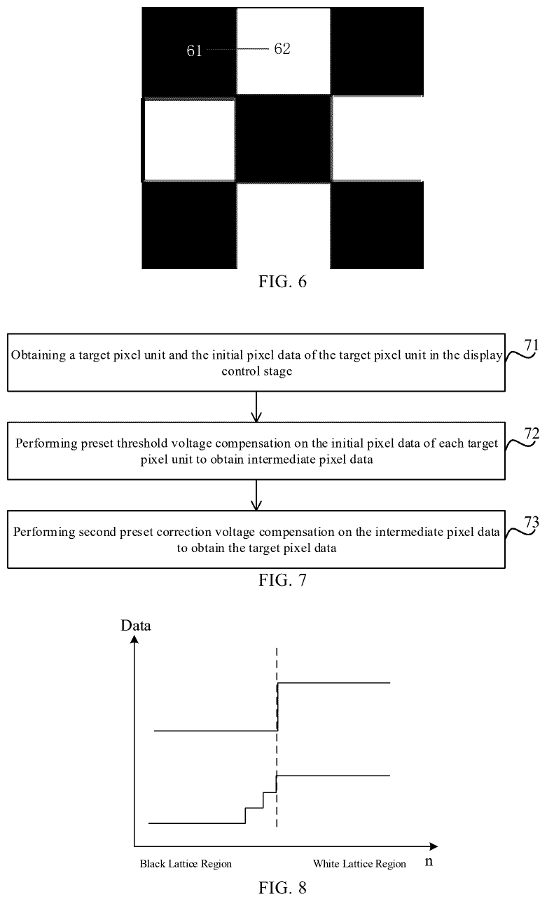

In another example, the target pixel unit includes a low gray-level pixel unit and/or at least one of adjacent pixel units of which the gray levels have a large difference therebetween. In an example of a black and white checkerboard image as shown in FIG. 6, a difference between the gray levels of a first pixel unit 61 and a second pixel unit 62 is large, and a probability of generating a residual image is large. In this case, the pixel data of the target pixel units needs to be processed. Referring to FIG. 7, the timing controller may correct the initial pixel data of each target pixel unit to obtain the target pixel data, including steps 71 to 73.

Step 71 includes, in the display control stage, obtaining a target pixel unit and the initial pixel data of the target pixel unit.

In the present step, the timing controller may, in the display control stage, obtain a target pixel unit and the initial pixel data of the target pixel unit, including: for each pixel unit in each row of pixel units of the display device, the timing controller may obtain a difference value between pixel data of a present pixel unit and pixel data of a next pixel unit, where the difference value may represent a difference in display brightness between the two pixel units; then, the timing controller may compare the difference with a preset difference threshold to obtain a comparison result.

In response to that the comparison result indicates that the difference is greater than the preset difference threshold, the timing controller may determine that the present pixel unit and at least one previous pixel unit are the target pixel units, and obtain pixel data of each target pixel unit as initial pixel data. It should be noted that the preset difference threshold may be preset (set or determined in advance), and any preset difference threshold that can distinguish between brightness and darkness of two pixel units falls into the protection scope of the present disclosure.

In response to that the comparison result indicates that the difference is less than or equal to the preset difference threshold, the timing controller may determine that the present pixel unit is not a target pixel unit, i.e., the present pixel unit is a pixel unit whose pixel data does not require a correction operation.

It should be noted that the preset difference threshold may be preset, may be a minimum value tested under the condition that a pixel unit with a high gray level can affect a threshold voltage of a pixel unit with a low gray level adjacent to the pixel unit with the high gray level, or may be a pixel difference that can identify a negative drift of the threshold voltage of the pixel unit, and an appropriate preset difference threshold may be selected according to an application scenario, which is not limited herein.

After determining the target pixel unit(s), the timing controller may obtain initial pixel data of each target pixel unit.

Step 72 includes performing preset threshold voltage compensation on the initial pixel data of each target pixel unit to obtain intermediate pixel data.

The details of step 72 are the same as those of step 42, may be referred to the content of step 42, and are not repeated here. In this way, the timing controller can obtain the intermediate pixel data of each target pixel unit in the present step.

Step 73 includes performing second preset correction voltage compensation on the intermediate pixel data to obtain the target pixel data, where the target pixel data is configured to keep the driving transistor of the target pixel unit forward biased and make an intensity of light emitted from the light emitting device of the target pixel unit different from an intensity of light emitted from an adjacent light emitting device.

In the present step, a second preset correction voltage is stored in the display device. The second preset correction voltage may be obtained in the same way as the first preset correction voltage, and in this case second preset correction voltages of target pixel units are equal to each other. In an example, with the present pixel unit as a reference, a target pixel unit that has a greater distance from the present pixel unit will have a smaller second preset correction voltage.

In the present step, the timing controller may perform the second preset correction voltage compensation on the intermediate pixel data to obtain the target pixel data. For example, the timing controller may obtain a second preset correction voltage of each target pixel unit, where a target pixel unit that has a greater distance from the present pixel unit will have a greater second preset correction voltage. Then, the timing controller may obtain a difference between the intermediate pixel data and the second preset correction voltage of each target pixel unit as the target pixel data.

Taking three target pixel units as an example, the present pixel unit is n and its initial pixel data is L(n); the next pixel unit of the present pixel unit n is n+1 and its initial pixel data is L(n+1); the previous pixel unit of the present pixel unit n is n−1 and its initial pixel data is L(n−1); the previous pixel unit of the previous pixel unit n−1 is n−2 and its initial pixel data is L(n−2); the modified target pixel data is as follows: the target pixel data L(n) of the present pixel unit n is L(n)=L(n)+Vth(n); the target pixel data L(n−1) of the previous pixel unit n−1 of the present pixel unit n is L(n−1)=L(n−1)+Vth(n−1)−b; and the target pixel data L(n−2) of the previous pixel unit n−2 of the previous pixel unit n−1 is L(n−2)=L(n−2)+Vth(n−2)−c.

In the present step, the effect of the pixel data of each target pixel unit before and after adjustment is as shown in FIG. 8. Referring to FIG. 8, a first curve (i.e., the upper curve) is the initial pixel data of a black lattice region and a white lattice before adjustment, and a second curve (i.e., the lower curve) is the target pixel data of the black lattice region and the white lattice after adjustment. Comparison indicates that, the target pixel data of three target pixel units corresponding to a portion of the second curve close to the white lattice region are sequentially increased, such that the light emitting brightness of the pixel units of the black lattice region and the white lattice region is gradually transited from black to white, thereby avoiding that a difference between the pixel data of two adjacent pixel units is great. It can be understood that, since the forward bias of the driving transistor is increased after the target pixel data is corrected, an intensity of light received by the black lattice region can be reduced, such that an illumination effect of each target pixel unit is reduced, the negative drift of the threshold voltage of each target pixel unit is reduced, and the phenomenon of line residual image is further mitigated.

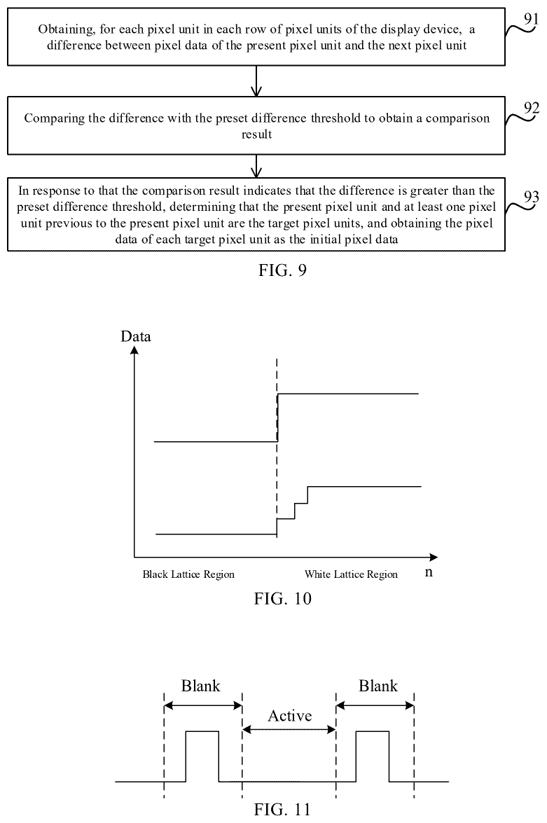

In yet another example, the target pixel unit includes a high gray-level pixel unit and/or at least one of adjacent pixel units of which the gray levels have a large difference therebetween. In an example of a black and white checkerboard image, referring to FIG. 6, the difference between the gray levels of the first pixel unit and the second pixel unit is large, and the probability of generating a residual image is large. In this case, the pixel data of the target pixel units needs to be processed. Referring to FIG. 9, the timing controller may correct the initial pixel data of each target pixel unit to obtain the target pixel data, including steps 91 to 93.

Step 91 includes, for each pixel unit in each row of pixel units of the display device, obtaining a difference value between pixel data of the present pixel unit and the next pixel unit.

The details of step 91 are the same as those of step 71, may be referred to the content of step 71, and are not repeated here.

Step 92 includes comparing the difference value with the preset difference threshold to obtain a comparison result.

The details of step 92 are the same as those of step 72, may be referred to the content of step 72, and are not repeated here.

Step 93 includes, in response to that the comparison result indicates that the difference value is greater than the preset difference threshold, determining the present pixel unit and at least one pixel unit next to the present pixel unit are the target pixel units, and obtaining the pixel data of each target pixel unit as the initial pixel data.

The details of step 93 are similar to those of step 73 except that the at least one pixel unit next to the present pixel unit is determined as the target pixel unit, may be referred to the content of step 73, and are not repeated here.

Taking three target pixel units as an example, the present pixel unit is n and its initial pixel data is L(n); the next pixel unit of the present pixel unit n is n+1 and its initial pixel data is L(n+1); the previous pixel unit of the present pixel unit n is n−1 and its initial pixel data is L(n−1); the previous pixel unit of the previous pixel unit n−1 is n−2 and its initial pixel data is L(n−2); the modified target pixel data is as follows: the target pixel data L(n+1) of the next pixel unit n+1 of the present pixel unit n is L(n+1)=L(n+1)+Vth(n+1)−d; the target pixel data L(n+2) of the next pixel unit n+2 of the next pixel unit n+1 is L(n+2)=L(n+2)+Vth(n+2)−e; and the target pixel data L(n+3) of the next pixel unit n+3 of the next pixel unit n+2 is L(n+3)=L(n+3)+Vth(n+3)−f.

In the present step, the effect of the pixel data of each target pixel unit before and after adjustment is as shown in FIG. 10. Referring to FIG. 10, a first curve (i.e., the upper curve) is the initial pixel data of a black lattice region and a white lattice before adjustment, and a second curve (i.e., the lower curve) is the target pixel data of the black lattice region and the white lattice after adjustment. Comparison indicates that, the target pixel data of three target pixel units corresponding to a portion of the second curve close to the black lattice region are sequentially increased, such that the light emitting brightness of the pixel units of the black lattice region and the white lattice region is gradually transited from black to white, thereby avoiding that a difference between the pixel data of two adjacent pixel units is great. It can be understood that, since the forward bias of the driving transistor is increased after the target pixel data is corrected, an intensity of light received by the black lattice region can be reduced, such that an illumination effect of each target pixel unit is reduced, the negative drift of the threshold voltage of each target pixel unit is reduced, and the phenomenon of line residual image is further mitigated.

In still another example, referring to FIG. 11, the non-display control stage (which is also referred to as a “blank stage”) refers to a stage between finishing displaying the present frame of image and starting displaying the next frame of image, or a time gap between the last line of the present frame of image and the first line of the next frame of image. In conjunction with the circuit shown in FIG. 2, during the non-display control stage, the timing controller may control the correction switch SW1 to be turned on, so as to write the preset level Vref on the preset level line ref into the source electrode of the driving transistor.

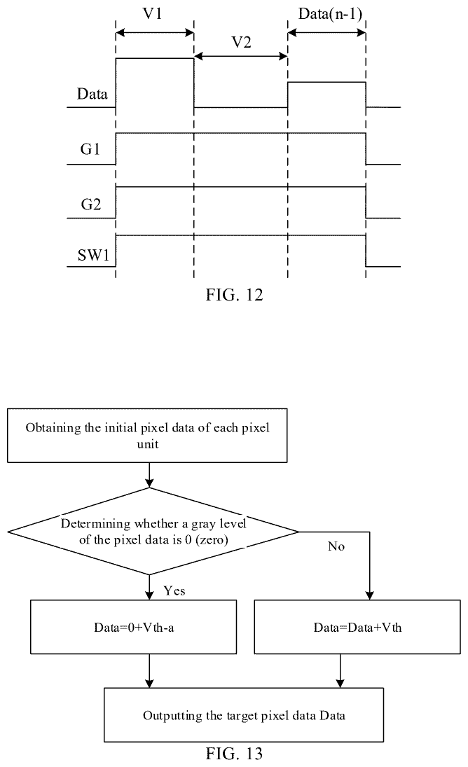

Referring to FIG. 12, in a first stage of the non-display control stage, the timing controller may adjust the initial pixel data of each target pixel unit to a first voltage V1 as the target pixel data. The first voltage is greater than a gray level voltage of the initial pixel data. The first voltage ranges from 5 V to 15 V, and in an example, the first voltage is 15 V.

In a second stage V2 of the non-display control stage, the timing controller may adjust the initial pixel data of each target pixel unit to a second voltage as the target pixel data. The second voltage is equal to the preset level output from the preset level line, and in an example, the second voltage is 0.

In a third stage of the non-display control stage, the timing controller may adjust the initial pixel data of each target pixel unit to the pixel data Data(n−1) of the previous frame of image as the target pixel data.

In the present example, in the first stage of the non-display control stage, the driving transistor of the pixel driving circuit is in a forward bias state; in the second stage, the target pixel data is set to be zero, such that the target pixel unit is in a non-display state; and in the third stage, the pixel data of the previous frame of image is restored to enable the driving transistor to be in the forward bias state again. Since the forward bias is increased in the first stage, the problem of residual image caused by the negative drift of the threshold voltage of the driving transistor can be mitigated.

Step 32 includes outputting the target pixel data to the target pixel unit.

In the present step, the timing controller may output the target pixel data to the target pixel unit, such that the intensity of light emitted from the light emitting device of the target pixel unit matches the target pixel data.

So far, the display device provided in the solution of the present embodiment can: correct the initial pixel data of the target pixel unit to obtain the target pixel data, where the target pixel data is configured to increase the forward bias of the driving transistor of the target pixel unit under a normal operation scene, and then, output the target pixel data to the target pixel unit. In this way, in the present embodiment, the pixel data is corrected such that the resultant target pixel data can increase the forward bias of the driving transistor of the target pixel unit, thereby mitigating or eliminating the surface residual image and/or the line residual image caused by the negative drift of the threshold voltage of the driving transistor, which is beneficial to the improvement of the display quality.

A control method provided by the present disclosure will be described below in conjunction with the following embodiments.

### Embodiment I

Referring to FIG. 13, taking the black and white checkerboard as an example, the initial pixel data Data of a pixel unit corresponding to the black lattice region is 0, and the timing controller can determine whether the pixel data of the image to be displayed is 0. In response to determining the pixel data is 0, the pixel unit is determined as a target pixel unit. In this case, the initial pixel data Data is added with a respective preset threshold voltage Vth1, and then a respective first preset correction voltage is subtracted therefrom, namely, Vgs=0+Vth−A, such that Vgs<Vth2, which can ensure that the target pixel unit does not emit light, and the driving transistor is forward biased.

In this way, in this example, Vth−a is added to the initial pixel data to perform correction to obtain the target pixel data, and a difference value matching the threshold voltage and the preset correction data a of each pixel unit is obtained, such that a data value tested when a black image is displayed is no longer 0, but is a value related to the threshold voltage Vth of the pixel unit, thereby making the pixel units have pieces of target pixel data, which are not exactly the same and fluctuate to form a wave shape as illustrated in FIG. 5.

### Embodiment II

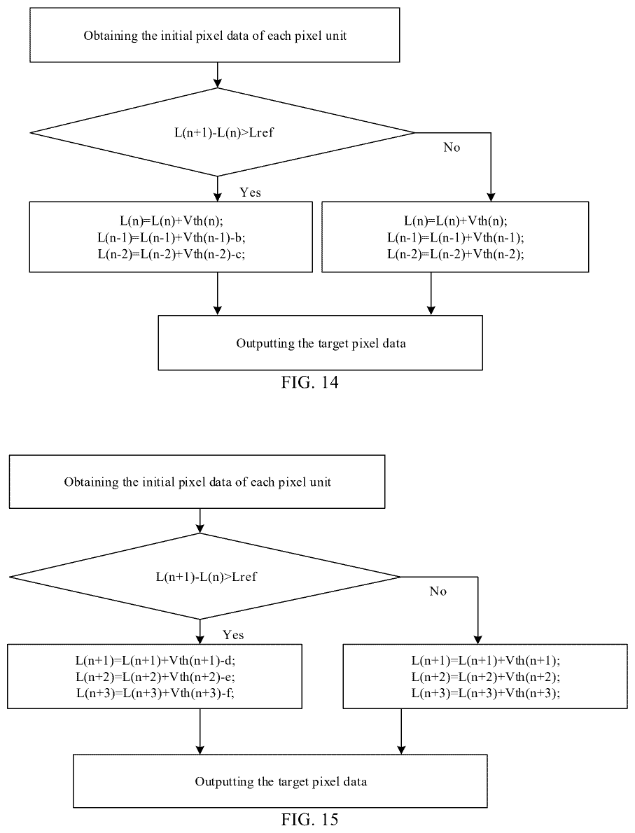

Taking a checkerboard picture as an example, referring to FIG. 14, the timing controller may obtain a difference between pixel data of two adjacent pixel units, and in response to that the difference is greater than a preset difference threshold (Lref), may determine that a target pixel unit with a large difference between high and low gray levels exists in the image to be displayed. For example, the timing controller compares the input pieces of pixel data, and compares the initial pixel data of the pixel unit in the n-th column and the initial pixel data of the pixel unit in the (n+1)-th column for each row of pixel units; in response to that a difference between the initial pixel data of the two pixel units is greater than the preset difference threshold, determines the pixel units in the n-th column, the (n−1)-th column, and the (n−2)-th column as target pixel units, performs compensation and correction on the respective initial pixel data of each of the target pixel units, as step 72 and step 73 of the solution shown in FIG. 7; namely, performs a decreasing increase on the initial pixel data of the target pixel units in the n-th column, the (n−1)-th column, and the (n−2)-th column, i.e., L(n)=L(n)+Vth(n), L(n−1)=L(n−1)+Vth(n−1)−b, and L(n−2)=L(n−2)+Vth(n−2)−c, and b is less than c, so as to make the target pixel data of the target pixel units in the (n−2)-th column, the (n−1)-th column, and the n-th column in a stepped-like increased relationship, of which the effect is shown in FIG. 8.

In the present embodiment, the driving transistors of the pixel units corresponding to an edge of the black lattice region can be subjected to forward bias, which can counteract or mitigate the negative drift of the threshold voltage caused by the illumination influence of the pixel units corresponding to the white lattice region, such that the line residual image is mitigated or eliminated.

### Embodiment III

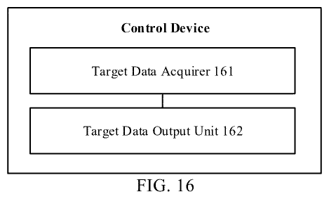

Taking the checkerboard picture as an example again, referring to FIG. 15, for each row of pixel units, the timing controller may compare the initial pixel data of the pixel unit in the n-th column with the initial pixel data of the pixel unit in the (n+1)-th column; in response to determining that a difference between the initial pixel data of the two pixel units is greater than the preset difference threshold, the timing controller may determine the pixel units in the (n+1)-th column, the (n+2)-th column, and the (n+3)-th column as the target pixel units, and in this case, may incrementally increase the initial pixel data of the pixel units in the (n+1)-th column, the (n+2)-th column, and the (n+3)-th column, i.e., L(n+1)=L(n+1)+Vth(n+1)−d, L(n+2)=L(n+2)+Vth(n+2)−e, and L(n+3)=L(n+3)+Vth(n+3)−f, where the relationship among the second preset correction voltages d, e and f is d>e>f.

In this way, the illumination effect on the pixel units corresponding to an edge of the black lattice region in the present embodiment can be reduced, and the phenomenon of negative drift of the threshold voltage Vth can be reduced, thereby mitigating the phenomenon of line residual image.

On the basis of the display device provided by the foregoing embodiments of the present disclosure, a control method is further provided by the embodiments of the present disclosure. Detailed description of the control method may be referred to the solutions in the contents shown in FIG. 3 to FIG. 13, and are not repeated here.

On the basis of the control method provided by the embodiments of the present disclosure, a control apparatus is further provided by the embodiments of the present disclosure, which is applicable to the display device. Referring to FIG. 16, the control apparatus includes:

a target data acquirer 161, configured to correct the initial pixel data of each target pixel unit to obtain the target pixel data, where the target pixel data is configured to increase the forward bias of the driving transistor of the target pixel unit under a normal operation scene; and
a target data output unit 162, configured to output the target pixel data to the target pixel unit.

In an embodiment, the target data acquirer includes:
an initial pixel data sub-determiner, configured to determine whether the initial pixel data of the target pixel unit is the first preset gray level in the display control stage;
an intermediate data sub-determiner, configured to perform preset threshold voltage compensation on the initial pixel data to obtain the intermediate pixel data, in response to that it is determined that the initial pixel data of the target pixel unit is the first preset gray level; and
a target data sub-acquirer, configured to perform first preset correction voltage compensation on the intermediate pixel data to obtain the target pixel data; and
the target pixel data is configured to keep the driving transistor of the target pixel unit forward biased and make the light emitting device of the target pixel unit not emit light.

In an embodiment, the target data sub-acquirer includes:
a first correction voltage acquirer, configured to obtain the first preset correction voltage corresponding to the target pixel unit; and
a target data acquirer unit, configured to obtain a difference between the intermediate pixel data and the first preset correction voltage as the target pixel data.

In an embodiment, the first correction voltage acquirer includes:
a correction voltage sub-adjustor, configured to set a correction voltage as an initial value and increase the correction voltage by a preset step length;
a test voltage sub-acquirer, configured to sequentially obtain a difference between the preset threshold voltage and the correction voltages as the test pixel voltages;
a first voltage sub-acquirer, configured to sequentially output the test pixel voltages to the target pixel unit, so as to obtain the first test pixel voltage that causes the target pixel to stop emitting light; and
a first correction voltage sub-acquirer, configured to set a correction voltage corresponding to the first test pixel voltage as the first preset correction voltage.

In an embodiment, the target data acquirer includes:
a target pixel sub-acquirer, configured to obtain a target pixel unit and the initial pixel data of the target pixel unit in the display control stage;
an intermediate data sub-acquirer, configured to perform the preset threshold voltage compensation on the initial pixel data of the target pixel unit to obtain the intermediate pixel data; and
a target data sub-acquirer, configured to perform the second preset correction voltage compensation on the intermediate pixel data to obtain the target pixel data;
where the target pixel data is configured to keep the driving transistor of the target pixel unit forward biased and make an intensity of light emitted from the light emitting device of the target pixel unit different from an intensity of light emitted from an adjacent light emitting device.

In an embodiment, the target pixel sub-acquirer includes:
a difference acquirer, configured to obtain, for each pixel unit in each row of pixel units of the display device, a difference between the pixel data of the present pixel unit and the pixel data of the next pixel unit;
a comparison result acquirer, configured to compare the difference with the preset difference threshold to obtain a comparison result; and
a target pixel determiner, configured to, in response to that the comparison result indicates that the difference is greater than the preset difference threshold, determine the present pixel unit and at least one pixel unit previous to the present pixel unit as the target pixel units, and obtain the pixel data of each of the target pixel units as the initial pixel data.

In an embodiment, the target data sub-acquirer includes:
a second correction voltage acquirer, configured to obtain the second preset correction voltage of each target pixel unit, where the target pixel unit, which is farther from the present pixel unit, has a greater second preset correction voltage; and
a target data acquirer unit, configured to obtain a difference between the intermediate pixel data and the second preset correction voltage of each target pixel unit as the target pixel data.

In an embodiment, the target pixel determiner is further configured to, in response to that the comparison result indicates that the difference is less than or equal to the preset difference threshold, determine that the present pixel unit is not the target pixel unit.

In an embodiment, the target pixel sub-acquirer includes:
a difference acquirer, configured to obtain, for each pixel unit in each row of pixel units of the display device, a difference between the pixel data of the present pixel unit and the pixel data of the next pixel unit;
a comparison result acquirer, configured to compare the difference with the preset difference threshold to obtain a comparison result; and
a target pixel acquirer unit, configured to determine, in response to that the comparison result indicates that the difference is greater than the preset difference threshold, the present pixel unit and at least one pixel unit next to the present pixel unit as the target pixel units, and obtain the pixel data of each of the target pixel units as the initial pixel data.

In an embodiment, the target data sub-acquirer includes:
a second correction voltage acquirer, configured to obtain the second preset correction voltage of each target pixel unit, where the target pixel unit, which is farther from the present pixel unit, has a smaller (or lower) second preset correction voltage; and
a target data acquirer unit, configured to obtain a difference between the intermediate pixel data and the second preset correction voltage of each target pixel unit as the target pixel data.

In an embodiment, the target pixel acquirer unit is further configured to, in response to that the comparison result indicates that the difference is less than or equal to the preset difference threshold, determine that the present pixel unit is not the target pixel unit.

In an embodiment, the pixel driving circuit of each pixel unit includes the correction switch, of which the first terminal is electrically connected to the source electrode of the driving transistor of the pixel driving circuit, and the second terminal is electrically connected to the preset level line; and the target data acquirer includes:
a correction switch sub-controller, configured to, in the non-display control stage, control the correction switch to be turned on so as to write the preset level on the preset level line into the source electrode of the driving transistor; and
a target pixel sub-acquirer, configured to: in the first stage of the non-display control stage, adjust the initial pixel data of the target pixel unit to the first voltage as the target pixel data, where the first voltage is greater than the gray level voltage of the initial pixel data; in the second stage of the non-display control stage, adjust the initial pixel data of the target pixel unit to the second voltage as the target pixel data, where the second voltage is equal to the preset level output from the preset level line; and in the third stage of the non-display control stage, adjust the initial pixel data of the target pixel unit to the pixel data of the previous frame of image as the target pixel data.

It should be noted that, the device provided in the present embodiment matches to the contents of the foregoing method embodiments, and reference may be made to the contents of the foregoing method embodiments, which is not repeated here.

In some possible embodiments, the present disclosure further provides a non-transitory computer readable storage medium, in which an executable computer program is stored, and when executed by a processor, the executable computer program implements the method according to any one of the embodiments as described above.

The terminology used in the present disclosure is for the purpose of describing particular embodiments only and is not intended to limit the present disclosure. Unless otherwise defined, technical or scientific terms used herein should have the same meaning as commonly understood by one of ordinary skill in the art to which the present disclosure belongs. The use of the terms “a”, “an”, or the like in the description and in the claims does not denote a limitation of quantity, but rather denote the presence of at least one element. The phrase “a plurality of” means at least two. The term of “comprising”, “including”, or the like, means that the element or item listed before “comprising” or “including” is inclusive of the element or item listed after “comprising” or “including”, and the equivalent thereof, and does not exclude the presence of additional elements or items. The term “connected”, “coupled”, or the like is not limited to physical or mechanical connections, but may include electrical connections, whether direct or indirect. As used in the present disclosure and the appended claims, the singular forms “a”, “an”, and “the” are intended to include the plural forms as well, unless the context clearly indicates otherwise. It should also be understood that the term “and/or” as used herein refers to and encompasses any and all possible combinations of one or more of the associated listed items.

For the method embodiments, since they substantially corresponds to the product embodiments, reference may be made to the description of the related parts of the apparatus embodiments for relevant points. The method embodiments and the product embodiments complement each other.

The above description is only for the purpose of explaining the exemplary embodiments of the present disclosure and is not intended to limit the present disclosure, and any modifications, equivalents, improvements and the like that are within the spirit and principle of the present disclosure fall within the scope of the present disclosure.

1. A display device, comprising a timing controller, a pixel array, and a data signal driver; wherein each of pixel units of the pixel array comprises a light emitting device and a pixel driving circuit for driving the light emitting device to emit light, the pixel driving circuit comprises a driving transistor, the timing controller is electrically connected to the data signal driver, and the data signal driver is electrically connected to the pixel units;
the timing controller is configured to correct initial pixel data of a target pixel unit to obtain target pixel data, and output the target pixel data to the data signal driver; and the target pixel data is configured to increase a forward bias of the driving transistor of the pixel driving circuit of the target pixel unit under a normal operation scene; and
the data signal driver is configured to output a driving voltage matching with the target pixel data to the target pixel unit so as to enable the driving transistor to keep forward biased in the normal operation scene.

2. The display device according to claim 1, wherein to correct initial pixel data of a target pixel unit to obtain target pixel data, the timing controller is further configured to:
in a display control stage, determine whether the initial pixel data of the target pixel unit is a first preset gray level, and the first preset gray level is a gray level voltage which enables the light emitting device not to emit light;
in response to that it is determined that the initial pixel data of the target pixel unit is the first preset gray level, perform preset threshold voltage compensation on the initial pixel data to obtain intermediate pixel data; and
perform first preset correction voltage compensation on the intermediate pixel data to obtain the target pixel data;
wherein the target pixel data is configured to keep the driving transistor of the target pixel unit forward biased and make the light emitting device of the target pixel unit not emit light.

3. The display device according to claim 2, wherein to perform first preset correction voltage compensation on the intermediate pixel data to obtain the target pixel data, the timing controller is further configured to:
obtain a first preset correction voltage corresponding to the target pixel unit; and
obtain a difference between the intermediate pixel data and the first preset correction voltage as the target pixel data.

4. The display device according to claim 3, wherein to obtain a first preset correction voltage corresponding to the target pixel unit, the timing controller is further configured to:
set a correction voltage as an initial value and increase the correction voltage by a preset step length;
sequentially obtain differences between a preset threshold voltage and correction voltages as test pixel voltages;
sequentially output the test pixel voltages to the target pixel unit to obtain a first test pixel voltage that enables the target pixel unit to stop emitting light; and
take the correction voltage corresponding to the first test pixel voltage as the first preset correction voltage.

5. The display device according to claim 1, wherein to correct initial pixel data of a target pixel unit to obtain target pixel data, the timing controller is further configured to:
in a display control stage, obtain the target pixel unit and the initial pixel data of the target pixel unit;
perform preset threshold voltage compensation on the initial pixel data of the target pixel unit to obtain intermediate pixel data; and
perform second preset correction voltage compensation on the intermediate pixel data to obtain the target pixel data;
wherein the target pixel data is configured to keep the driving transistor of the target pixel unit forward biased and make an intensity of light emitted from the light emitting device of the target pixel unit different from an intensity of light emitted from an adjacent light emitting device.

6. The display device according to claim 5, wherein to obtain the target pixel unit and the initial pixel data of the target pixel unit, the timing controller is further configured to:
for each pixel unit in each row of pixel units of the display device, obtain a difference between pixel data of a present pixel unit and pixel data of a next pixel unit;
compare the difference with a preset difference threshold to obtain a comparison result; and
in response to that the comparison result indicates that the difference is greater than the preset difference threshold, determine the present pixel unit and at least one pixel unit previous to the present pixel unit as target pixel units, and obtain the pixel data of each of the target pixel units as the initial pixel data.

7. The display device according to claim 6, wherein to perform second preset correction voltage compensation on the intermediate pixel data to obtain the target pixel data, the timing controller is further configured to:
obtain a second preset correction voltage of each target pixel unit, wherein the target pixel unit, which is farther from the present pixel unit, has a greater second preset correction voltage; and
obtain a difference between the intermediate pixel data and the second preset correction voltage of each target pixel unit as the target pixel data.

8. The display device according to claim 6, wherein to obtain the target pixel unit and the initial pixel data of the target pixel unit, the timing controller is further configured to:
in response to that the comparison result indicates that the difference is less than or equal to the preset difference threshold, determine that the present pixel unit is not the target pixel unit.

9. The display device according to claim 5, wherein to obtain the target pixel unit and the initial pixel data of the target pixel unit, the timing controller is further configured to:
for each pixel unit in each row of pixel units of the display device, obtain a difference between pixel data of a present pixel unit and pixel data of a next pixel unit;
compare the difference with a preset difference threshold to obtain a comparison result; and
in response that the comparison result indicates that the difference is greater than the preset difference threshold, determine the present pixel unit and at least one pixel unit next to the present pixel unit as target pixel units, and obtain the pixel data of each of the target pixel units as the initial pixel data.

10. The display device according to claim 9, wherein to perform second preset correction voltage compensation on the intermediate pixel data to obtain the target pixel data, the timing controller is further configured to:
obtain a second preset correction voltage of each target pixel unit, wherein the target pixel unit, which is farther from the present pixel unit, has a smaller second preset correction voltage; and
obtain a difference between the intermediate pixel data and the second preset correction voltage of each target pixel unit as the target pixel data.

11. The display device according to claim 9, wherein to obtain the target pixel unit and the initial pixel data of the target pixel unit, the timing controller is further configured to:
in response to that the comparison result indicates that the difference is less than or equal to the preset difference threshold, determine that the present pixel unit is not the target pixel unit.

12. The display device according to claim 1, wherein the pixel driving circuit of each pixel unit comprises a correction switch, a first terminal of the correction switch is electrically connected to a source electrode of the driving transistor of the pixel driving circuit, and a second terminal of the correction switch is electrically connected to a preset level line; to correct initial pixel data of a target pixel unit to obtain target pixel data, the timing controller is further configured to:
in a non-display control stage, control the correction switch to be turned on so as to write a preset level on the preset level line into the source electrode of the driving transistor;
in a first stage of the non-display control stage, adjust the initial pixel data of the target pixel unit to a first voltage as the target pixel data, wherein the first voltage is greater than a gray level voltage of the initial pixel data;
in a second stage of the non-display control stage, adjust the initial pixel data of the target pixel unit to a second voltage as the target pixel data, wherein the second voltage is equal to the preset level output from the preset level line; and
in a third stage of the non-display control stage, adjust the initial pixel data of the target pixel unit to pixel data of a previous frame of image as the target pixel data.

13. A control method applicable to a display device, the control method comprising:
correcting initial pixel data of a target pixel unit to obtain target pixel data, wherein the target pixel data is configured to increase a forward bias of a driving transistor of the target pixel unit under a normal operation scene; and
outputting the target pixel data to the target pixel unit.

14. A control apparatus applicable to a display device, the control apparatus comprising:
a target data acquirer configured to correct initial pixel data of a target pixel unit to obtain target pixel data, wherein the target pixel data is configured to increase a forward bias of a driving transistor of the target pixel unit under a normal operation scene; and
a target data output unit configured to output the target pixel data to the target pixel unit.

15. A non-transitory computer readable storage medium, having an executable computer program stored therein, wherein when executed by a processor, the computer program implements the control method according to claim 13.
